(19) United States
(12) Patent Application Publication
(10) Pub. No.: US 2012/0209549 A1
(43) Pub. Date: Aug. 16, 2012

(54) EQUIPMENT-RELATED RISK ASSESSMENT FROM ELECTRICAL EVENT ANAYSIS

(75) Inventors: Roger William COX, McDonald, PA (US); Frank KLANCHER, Pittsburgh, PA (US); Donald Thompson McCOMAS, Oakdale, PA (US)

(73) Assignee: EATON CORPORATION, Cleveland, OH (US)

(21) Appl. No.: 13/024,540

(22) Filed: Feb. 10, 2011

(51) Int. Cl. G06F 19/00

(52) U.S. Cl. 702/61

(57) ABSTRACT

Methods and apparatus are provided for assessing equipment related risk based on electrical event data. An electrical event is an electrical voltage or current that falls outside a nominal range during an event duration. The electrical event data for electricity supplied to electrically-powered equipment is analyzed and one or more types of equipment related risk associated with an electrical event are quantified based on the electrical event data. A visual representation of the quantified one or more equipment related risks is provided.

### BACKGROUND

Determining business planning implications from technical operating data, such the quality of electrical power supplied to equipment, can be challenging. This is because technical operating data is presented in terms not readily understood by those not versed in the particular technical area. Thus, while many metering products monitor and summarize technical operating data, they may fail to present the information in a manner that can readily provide guidance for business planning.

### SUMMARY

Methods and apparatus are provided for assessing equipment related risk based on electrical event data. An electrical event is an electrical voltage or current that falls outside a nominal range during an event duration. The electrical event data for electricity supplied to electrically-powered equipment is analyzed and one or more types of equipment related risk associated with an electrical event are quantified based on the electrical event data. A visual representation of the quantified one or more equipment related risks is provided.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of a scatter plot for representing equipment related risk.

FIG. 2A is a functional block diagram of one embodiment of a system that assesses equipment related risk based on electrical event data.

FIG. 2B illustrates a graphical representation of electrical event data.

FIG. 3 is a flow diagram outlining one embodiment of a method for assessing equipment related risk based on electrical event data.

FIG. 4 is a flow diagram outlining one embodiment of a method for quantifying equipment related risk based on electrical event data for representation on a graph.

FIG. 5 illustrates an embodiment of a computing system in which example systems and methods, and equivalents, may operate.

### DETAILED DESCRIPTION

The quality of electrical power supplied to the equipment in an enterprise has short and long term business risk implications. For example, when the voltage supplied to equipment falls below a nominal value the equipment may shut down due to insufficient power. This low voltage condition, called a sag, creates process risk because the processes performed by the equipment may be interrupted. Process risk is a relatively short term risk that can happen unexpectedly and have serious financial impact if important functions are interrupted.

When voltage supplied to equipment rises above a nominal value, which is typically called a swell, the equipment may be damaged due to overheating or arcing. While the equipment may continue to function during and after a swell, it may have sustained incremental damage that will shorten the time until it must be repaired or replaced. Thus, swells tend to create capital risk associated with shortened equipment lifespan.

Process risk and capital risk present different business planning implications that should be factored into decision making. Some metering systems are capable of rating the severity of sags and swells and presenting the rating information in graphical form. However, these metering systems do not quantify business planning risk associated with the sags and swells experienced by an enterprise's equipment.

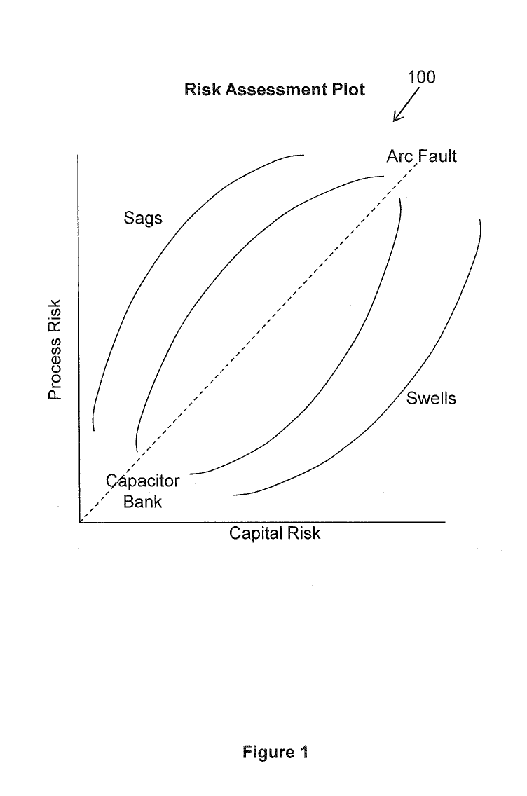

In one embodiment, the quantified process risk and capital risk can be communicated by way of a visual representation such as the scatter plot 100 shown in FIG. 1. The scatter plot 100 plots process risk Rₚ against capital risk R_{c}. Each electrical event is assigned (x,y) coordinates to be positioned on the scatter plot. A business planner can then refer to the plot to readily ascertain a level of process risk and capital risk associated with any given electrical event. Sags will generally result in a point in the top diagonal half of the plot because sags typically result in higher process risk and, to a lesser extent, capital risk. Swells will generally result in a point in the bottom diagonal half of the plot because swells typically result in higher capital risk while not usually resulting in process interruption.

Events that fall at the high end of both process and capital risk may be the result of an arc fault event. These types of events may be a safety concern and a business planner may want to further investigate when such an event occurs. Events that fall at the low end of both process and capital risk are often sub-cycle (short in duration) events such as a switching or addition of a power-factor correction capacitor, which is a routine occurrence that incurs negligible risk. The scatter plot may include additional labels in various regions to provide context for the points on the plot. The labels may be tailored to a specific site or equipment.

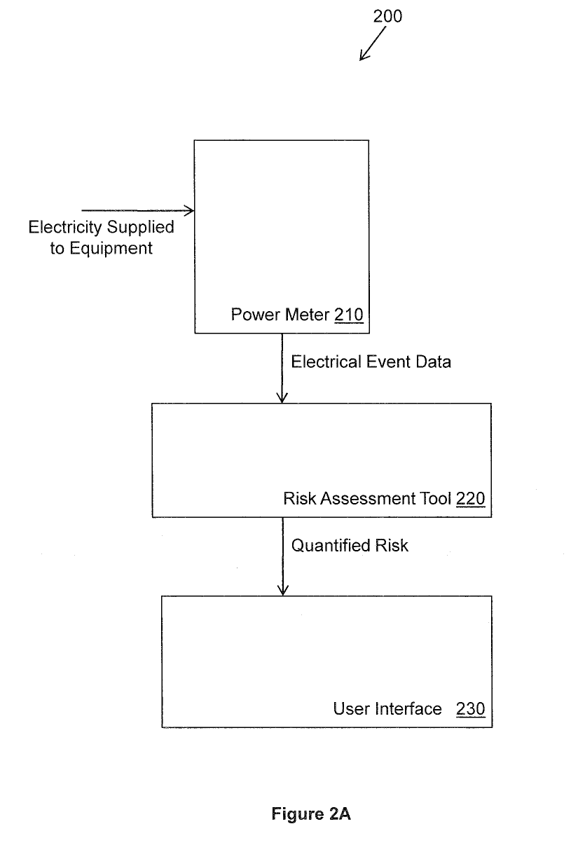

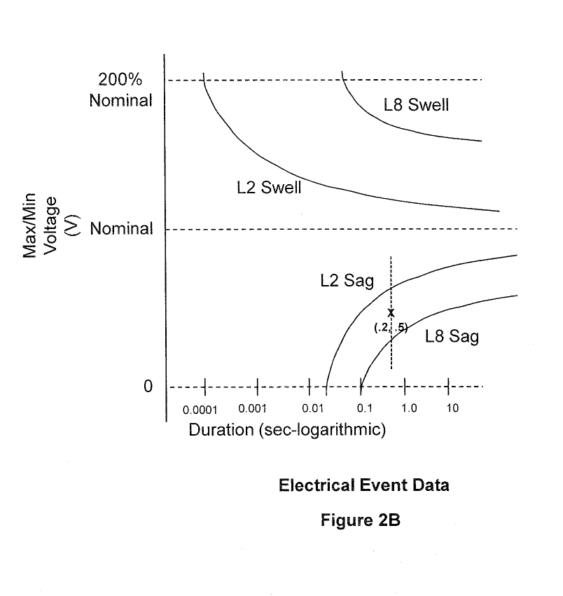

FIG. 2A illustrates an example embodiment of a system 200 that includes a risk assessment tool 220 that inputs electrical event data and outputs quantified equipment related risk in the form of a risk assessment scatter plot (100 in FIG. 1). For the purposes of this description, electrical event data includes data describing instances in which electrical voltage or current supplied to the equipment rises or falls above a nominal range. In this description the electrical events will usually be categorized as either voltage swells or sags. However, other irregularities in electricity supplied to equipment may also be analyzed by the system 200 to produce a quantified risk.

In some embodiments, the system 200 includes a meter 210 that monitors electricity supplied to equipment and produces the electrical event data. The risk assessment tool 220 may reside in a specially equipped meter. In other embodiments, the risk assessment tool 220 may reside in a remote device connected to the meter 210 by way of a web server (not shown). In this embodiment, several meters may provide electrical data to the same risk assessment tool 220 via the Internet. The system 200 will typically include electronic storage media (not shown) in either the meter 210 or risk assessment tool 220, or both, for storing the electrical event data for analysis purposes. The system 200 includes a user interface 230 configured to communicate the quantified risk (e.g., scatter plot) produced by the risk assessment tool 220. As with the meter 210, the user interface 230 may be provided as part of a specially equipped meter or by way of a remote device coupled to a web server.

FIG. 2B illustrates a typical representation of electrical event data. A voltage sag is characterized using a standard acceptability curve described by the following equation:

V=0.87−0.159e^{-0158T}−0.841e^{-4.63}/(1−e^{-4.63T}) (EQ 1)

The voltage V is the lowest voltage that occurs during the sag event and the time T is the duration of time during which the voltage was below nominal. Voltage is represented as a percent of nominal and time is presented in seconds on a logarithmic scale. Equation 1 describes a Level 2 (L2) sag which is considered to present a lowest “acceptable” sag. A Level 8 (L8) sag, which is consider to present a maximum possible process risk is described by Equation 2:

V=0.55−0.159e^{-0158T}−0.841e^{-4.63}/(1−e^{-4.63T}) (EQ 2)

Intermediate levels may be interpolated between the L2 and L8 levels. For example, an L5 curve would be the average of the L2 and L8 curves. In some existing metering systems, a sag event is fitted to a nearest curve so that it can be classified as one of seven levels (L2-L8). Sag events that fall above the L2 curve are categorized as L2 sag events and sag events that fall below the L8 curve are characterized as L8 sag events.

Using the same formula with different coefficients, an L2 (lowest acceptable) swell can be characterized by Equation 3 and an L8 (maximum) swell can be characterized by Equation 4:

V=1.1+5e^{-2000T}+0.1e^{-3T} (EQ 3)

V=1.4+3e^{-200T}+0.3e^{-12T} (EQ 4)

Intermediate levels may be interpolated between the L2 and L8 levels. For example, an L5 curve would be the average of the L2 and L8 curves. In some existing metering systems, a swell event is fitted to a nearest curve so that it can be classified as one of seven levels (L2-L8). Swell events that fall below the L2 curve are categorized as L2 swell events and swell events that fall above the L8 curve are characterized as L8 swell events.

Some existing metering systems provide an integer level rating between 2 and 8 for sag and swell events. However to produce a process risk and capital risk scatter plot like the one shown in FIG. 1, it is advantageous to derive a continuous value for a sag or swell level. To interpolate a continuous level rating for a sag event, the sag event is defined by its depth and duration. In calculating the sag level, if the per-unit voltage for a given duration is below the L8, it is assigned a sag level of 8. If the per-unit voltage for a given duration is above the L2 sag curve, it is assigned a sag level of 1. Otherwise, the continuous sag level is calculated such that:

Sag level=m*depth+b

where

m=(8−2)/(V_{L8sag}(T)V_{L2sag}(T)) and

b=2−mV_{L2sag}(T)

For example, to calculate the continuous sag level for a 200 ms sag with a voltage depth at 50% of nominal, Equations 1 and 2 are solved for T=200 ms. The resulting V_{L2sag} and V_{L8sag} are then used to derive a slope of −2.67 and an intercept of 3.69. (see point marked “x” on the plot in FIG. 2A). The sag level is then calculated, by solving the resulting linear equation, as:

Sag level=−2.67(0.5)+3.69=2.36

To interpolate a continuous level rating for a swell event, the swell event is defined by its depth and duration. In calculating the swell level, if the per-unit voltage for a given duration is above the L8, it is assigned a swell level of 8. If the per-unit voltage for a given duration is below the L2 swell curve, it is assigned a swell level of 1. Otherwise, the continuous swell level is calculated such that:

Swell level=m*height+b

where

m=(8−2)/(V_{L8swell}(T)−V_{L2swell}(T)) and

b=2−mV_{L2swell}(T)

For example, to calculate the continuous swell level for a 0.1 s sag with a voltage of 120% of nominal, Equations 3 and 4 are solved for T=0.1 s. The resulting V_{L2swell} and V_{L8swell} are then used to derive a slope of 22 and an intercept of −22.9. The swell level is then calculated as:

Swell level=22(1.2)−22.9=3.54

The risk assessment tool 220 uses the continuous sag or swell level for a given electrical event to quantify a process risk Rₚ and capital risk R_{c} associated with the electrical event. As already discussed above, a process risk is typically short-term and involves the consequences of interruption of processes due to insufficient voltage. In contrast a capital risk is typically a long-term risk that involves accumulated damage that may result in an unsafe working environment as well as repair or replacement of equipment. The quantified process risk and capital risk are communicated by way of the user interface 230. In one embodiment, the quantified process risk and capital risk are communicated by way of the scatter plot 100 shown in FIG. 1.

In one embodiment the risk assessment tool 220 (FIG. 2A) quantifies process and/or capital risk given a continuous sag or swell level as follows. Given a sag:

Rₚ(y coordinate on the scatter plot 2B)=Continuous Sag Level

R_{c}(x coordinate)=ln(Rₚ*Number of Sags at this Level).

Given a swell:

R_{c}=(Continuous Swell Level*0.27)*ln(Continuous Swell Level*Number of Swells at this Level).

Rₚ=square root of R_{c}

It can be seen that the capital risk associated with either a sag or a swell is increased based on a number of sags or swells that have already happened. This captures the incremental accumulation of damage that increases capital risk so that the first electrical event of a given type will result in a lower capital risk than the tenth electrical event of the same type. Process risk may also be augmented based on electrical data that indicates that equipment has shut down due to an electrical event.

In addition to sags and swells, process and capital risk associated with voltage spikes may also be characterized. In one embodiment, a voltage spike is treated as a swell having a 1 ms duration. Thus the continuous swell level would be calculated by: 22*Vₚₑₐₖ/1.414Nᵣₘₛ−23. For an 800 V spike on a 480 V system, the continuous swell level would be calculated as 2.9. Given the continuous swell level, Rₚ and R_{c} can be calculated as already described.

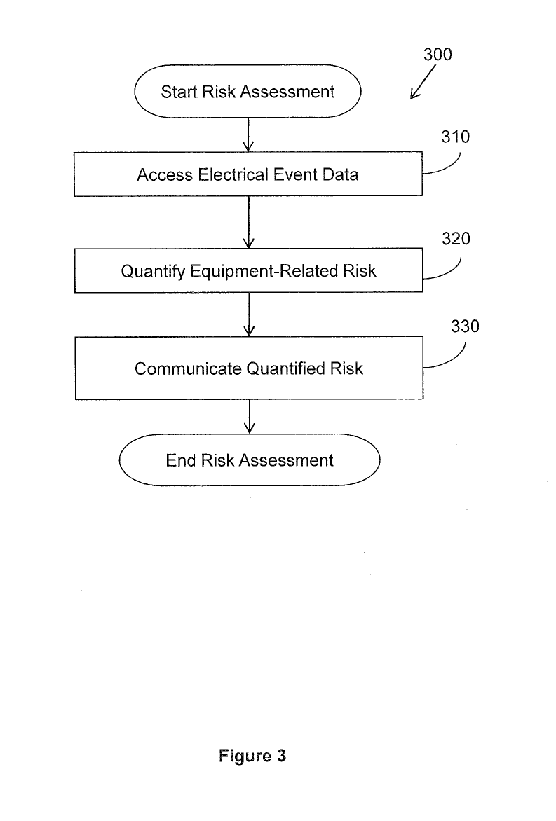

FIG. 3 is a flow diagram outlining one embodiment of a method 300 that assesses equipment related risk based on electrical event data. At 310 electrical event data in the form of maximum voltage differential as a percent of nominal and duration of the event is accessed. The maximum voltage differential and duration can be determined from root mean square readings or with reference to a waveform produced by the meter 210 (FIG. 2A). At 320, one or more types of equipment related risk associated with an electrical event are quantified based on the electrical event data. The electrical event data is used to calculate a continuous sag or swell level as described above. The continuous sag or swell level then serves as a basis for quantifying an amount of process risk and capital risk associated with the event. At 330, the quantified equipment related risk is communicated. In one embodiment, the quantified equipment related risk is communicated by way of a scatter plot (see FIG. 1).

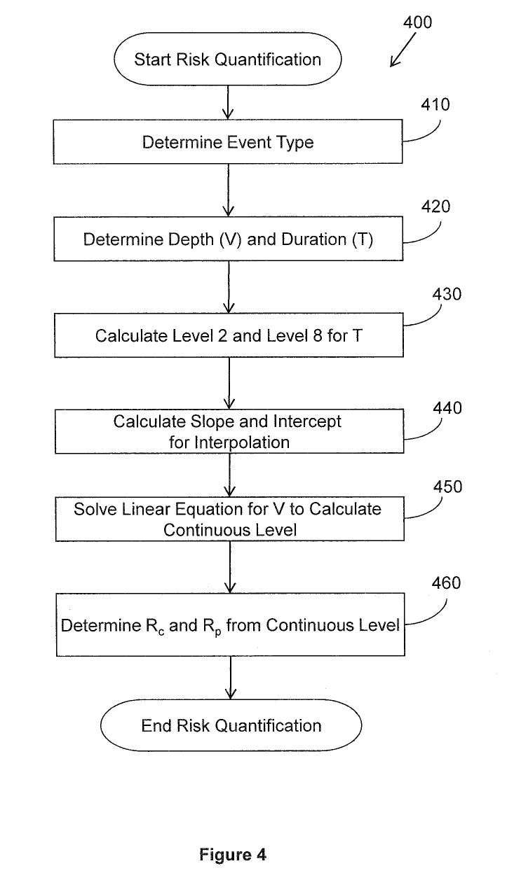

FIG. 4 is a flow diagram illustrating one embodiment of a method 400 that can be used by the risk assessment tool 120 (FIG. 1) to quantify capital risk R_{c} and process risk Rₚ associated with an electrical event. At 410, the method determines the event type (e.g., sag or swell). At 420, the method determines an event depth (V) corresponding to a maximum difference between the electrical voltage and a nominal value. Of course, current (I) could be used instead of voltage to perform the method. The method also determines a duration (T) of the event. At 430, the method calculates the limits of the range of interest, the Level 2 and Level 8 voltage for a sag or swell as determined at 410, at the time T. At 440, the method calculates a slope and intercept using the Level 2 and Level 8 voltages for interpolation. At 450, the method calculates a continuous sag or swell level by solving the linear equation from 440 using V. At 460, the method determines the capital risk R_{c} and process risk Rₚ using the continuous sag or swell level. R_{c} and Rₚ can then be communicated for business planning purposes.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the methods outlined in FIGS. 3 and 4 and described in detail above.

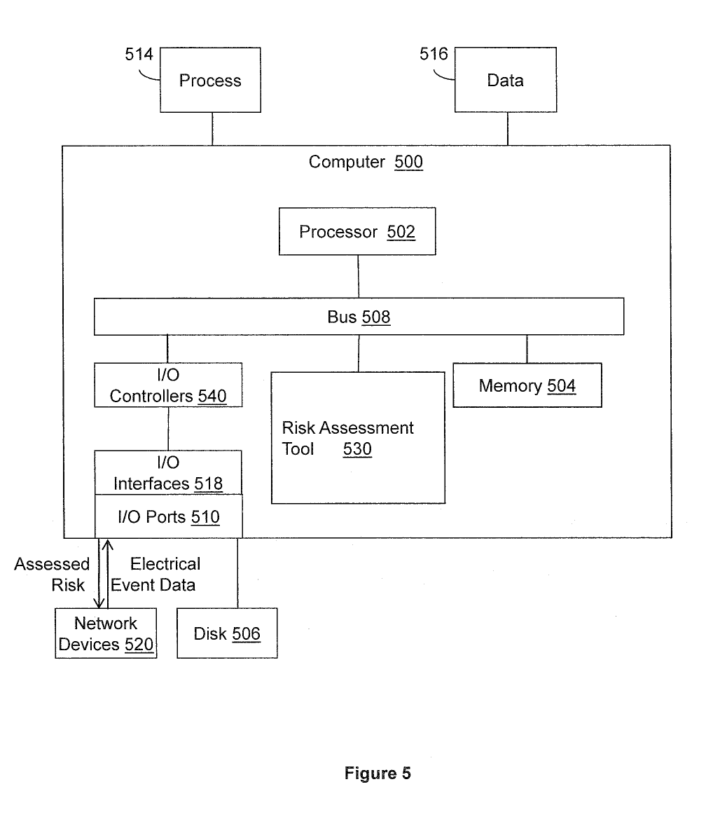

FIG. 5 illustrates an example computing device in which example systems and methods described herein, and equivalents, may operate. The example computing device may be a computer 500 that includes a processor 502, a memory 504, and input/output ports 510 operably connected by a bus 508. In one example, the computer 500 may include a risk assessment tool 530 configured to facilitate assessing equipment related risk from electrical event data. In different examples, the risk assessment tool 530 may be implemented in hardware, a non-transitory computer-readable medium with stored instructions, firmware, and/or combinations thereof. While the risk assessment tool 530 is illustrated as a hardware component attached to the bus 508, it is to be appreciated that in one example, the risk assessment tool 530 could be implemented in the processor 502.

In one embodiment, risk assessment tool 530 is a means (e.g., hardware, non-transitory computer-readable medium, firmware) for assessing equipment related risk from electrical event data.

The means may be implemented, for example, as an ASIC programmed to assess equipment related risk from electrical event data. The means may also be implemented as stored computer executable instructions that are presented to computer 500 as data 516 that are temporarily stored in memory 504 and then executed by processor 502.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the I/O interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520, including meters gathering electrical event data, via the I/O interfaces 518, and/or the I/O ports 510. Through the network devices 520, the computer 500 may interact with a network. Through the network, the computer 500 may be logically connected to remote computers. Networks with which the computer 500 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

What is claimed is:

1. A method comprising:
accessing electrical event data for electricity supplied to electrically-powered equipment, where an electrical event comprises an electrical voltage or current that falls outside a nominal range during an event duration;
quantifying one or more types of equipment related risk associated with an electrical event, based, at least in part, on the electrical event data; and
communicating the quantified one or more equipment related risks.

2. The method of claim 1 comprising assigning a continuous event level corresponding to a severity of the electrical event based on the event duration and a maximum difference between the electrical voltage or current and the nominal range and quantifying the one or more types of equipment related risk based, at least in part, on the assigned level.

3. The method of claim 2 comprising categorizing an electrical event in which an electrical voltage falls below the nominal range as a sag and categorizing an electrical event in which an electrical voltage rises above the nominal range as a swell.

4. The method of claim 3 comprising quantifying a process risk based on an event level assigned to a sag and deriving a corresponding capital risk from the process risk.

5. The method of claim 4 comprising increasing the process risk quantified based on the sag event level based on equipment power consumption data that indicates that equipment function was comprised by the swell event.

6. The method of claim 3 comprising quantifying a capital risk based on an event level assigned to a swell and deriving a corresponding process risk from the capital risk.

7. The method of claim 6 comprising increasing the capital risk quantified based on a swell event level in proportion to a number of swells that have already occurred.

8. The method of claim 1 where communicating the quantified one or more equipment related risks comprises providing a visual representation of the quantified one or more equipment related risks comprises rendering a quantified process risk and a quantified capital risk on an x-y plot having an x axis corresponding to capital risk and a y axis corresponding to process risk.

9. A system comprising:
storage media for storing electrical event data for electricity supplied to electrically-powered equipment, where an electrical event comprises an electrical voltage or current that falls outside a nominal range during an event duration;
a risk assessment tool configured to quantify one or more types of equipment related risk associated with an electrical event, based, at least in part, on the electrical event data; and
a user interface configured to communicate the quantified one or more equipment related risks.

10. The system of claim 9 where one or more of the storage media, risk assessment tool, and user interface are housed within a power meter that generates the electrical event data.

11. The system of claim 9 where one or more of the storage media, risk assessment tool, and user interface are provided by a web server that is configured to access electrical event data from a power meter that generates the electrical event data.

12. Non-transitory computer-readable medium storing computer-executable instructions for performing a method comprising:
accessing electrical event data for electricity supplied to electrically-powered equipment, where an electrical event comprises an electrical voltage or current that falls outside a nominal range during an event duration;
quantifying one or more types of equipment related risk associated with an electrical event, based, at least in part, on the electrical event data; and
communicating the quantified one or more equipment related risks.

13. The non-transitory computer-readable medium of claim 12 where the method comprises assigning a continuous event level corresponding to a severity of the electrical event based on the event duration and a maximum difference between the electrical voltage or current and the nominal range and quantifying the one or more types of equipment related risk based, at least in part, on the assigned level.

14. The non-transitory computer-readable medium of claim 13 where the method comprises categorizing an electrical event in which an electrical voltage falls below the nominal range as a sag and categorizing an electrical event in which an electrical voltage rises above the nominal range as a swell.

15. The non-transitory computer-readable medium of claim 14 where the method comprises quantifying a process risk based on an event level assigned to a sag and deriving a corresponding capital risk from the process risk.

16. The non-transitory computer-readable medium of claim 15 where the method comprises increasing the process risk quantified based on the sag event level based on equipment power consumption data that indicates that equipment function was comprised by the swell event.

17. The non-transitory computer-readable medium of claim 14 where the method comprises quantifying a capital risk based on an event level assigned to a swell and deriving a corresponding process risk from the capital risk.

18. The non-transitory computer-readable medium of claim 17 where the method comprises increasing the capital risk quantified based on a swell event level in proportion to a number of swells that have already occurred.

19. The non-transitory computer-readable medium of claim 12 where communicating the quantified one or more equipment related risks comprises providing a visual representation of the quantified one or more equipment related risks comprises rendering a quantified process risk and a quantified capital risk on an x-y plot having an x axis corresponding to capital risk and a y axis corresponding to process risk.
